(19) United States
(12) Patent Application Publication
(10) Pub. No.: US 2007/0214199 A1
(43) Pub. Date: Sep. 13, 2007

(54) Method for registering information for searching

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/716,287

(22) Filed: Mar. 8, 2007

Related U.S. Application Data
(60) Provisional application No. 60/780,743, filed on Mar. 9, 2006.
(60) Provisional application No. 60/783,476, filed on Mar. 18, 2006.
(60) Provisional application No. 60/782,893, filed on Mar. 16, 2006.

(51) Int. Cl. G06F 17/30

(52) U.S. Cl. 707/204

(57) ABSTRACT

A method and system for authoring information for searching implementing the information generating entity, such as a website author for identifying at least one of a: concept of a word capable of identifying several concepts, a new concept of a word, and a new word.

### RELATED APPLICATIONS

This is application claims the benefit of: U.S. provisional patent application Ser. No. 60/780,743, filed 2006 Mar. 8, U.S. provisional patent application Ser. No. 60/782,893 filed 2006 Mar. 16 and U.S. provisional patent application Ser. No. 60/783,476 filed 2006 Mar. 18 by the present inventor.

### BACKGROUND

1. Field of Invention

The present invention relates generally to a method for the storage and search of information. More particularly, a novel method of registering information for searching, wherein an information identifying a word or group of words comprises a plurality of meanings or adopts at least one new meaning. 2. Description of Related Art

The Revolution of the Internet and its massive quantities of information are the reason why every day, more and more people use search engines to find what is important to them and what they are looking for. However, in any particular language, it is possible that a word or group of words can have several meanings, or that eventually an additional meaning can be adopted. For example, the word “dog” identifies an animal, but it can also identify a tool, and a despicable person. As a matter of fact, it can be said that it is rather recently that word “dog” took the new meaning of identifying a tool. Furthermore, the evolution of technology, development of new machines, new services and stronger interactions between current and/or future cultures implies that currently used words can be used to identify new and even complex meanings, thus increasing or modifying their connotative functions. Therefore, there is a growing need to identify the proper concept of a word(s), and furthermore to allow the information generating entities and persons to identify or distinguish the current meanings with possible future meanings so search engines or other information seeking entities do not confuse or mix results comprising conceptual differences.

In view of the present shortcomings, the present invention distinguishes over the prior art by providing heretofore a method to allow information providers, such as search engines, websites, people, etc. to distinguish or differentiate between the several meanings that a word or group of words has or can adopt, while providing additional unknown, unsolved and unrecognized advantages as described in the following summary.

### SUMMARY OF THE INVENTION

The present invention teaches certain benefits in use and construction which give rise to the objectives and advantages described below. The methods and systems embodied by the present invention overcome the limitations and shortcomings encountered when new and current information identifying a word has several meanings, assumes new meaning(s) or identifies new words. The method permits storage information entities and/or searching information entities to reduce the resources needed for identifying information by allowing the information generating entities, such as websites, and authors to share the conceptual identifying responsibilities of words that are capable of identifying several concepts, new concepts of a word, and new words.

### OBJECTS AND ADVANTAGES

A primary objective inherent in the above described method of use is to provide a method for identifying information comprising several meanings and/or adopting a new meaning not taught by the prior arts and further advantages and objectives not taught by the prior art. Accordingly, several objects and advantages of the invention are

Another objective is to avoid the origination of irrelevant data when searching.

Another objective is to update current information.

Another objective is to update future information.

A further objective is to decrease the expenses or reduce the effort required for an information storing and/or information searching entity to identify the proper meaning of a word.

A further objective is to reduce the time required for a searching system to retrieve information.

A further objective is to tabulate the results generated by a search engine when a word in the query has several meanings.

A further objective is to quickly permit the acknowledgement of new concepts and/or connotative functions.

A further objective is to quickly permit the acknowledgement of concepts of new words.

A further objective is to enable the cognitive manipulation of multi-conceptual words and their meanings.

Another objective is to permit searching of information from one language to another wherein in one of the languages a word or words have multiple meanings.

Another further objective is to permit information generating entities to control and identify the meaning of the information they provide.

Another further objective is to permit the incorporation of identifiers instead of text, thus allowing the unification of the world's knowledge regardless of language.

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate examples of at least one of the best mode embodiments of the present method of use. In such drawings:

FIG. 1 illustrates a non-limiting block diagram of the inventive method implementing the information generating entity for identifying at least one meaning of a word;

FIG. 2 illustrates a diagram of additional steps of the inventive method of implementing a search engine entity for manipulating the information;

FIGS. 3A and FIG. 3B illustrate non-limiting views of a program for selecting a meaning of a word that has several meanings;

FIG. 4 illustrates a non-limiting view of a variation of the inventive method, wherein a new information is submitted by a client to a search engine entity.

FIG. 5 illustrates an information generating entity identifying a new meaning or unidentified meaning of a word.

FIG. 6 illustrates an information searching entity identifying a new word and implementing the information generating entity for identifying a concept of said new word

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

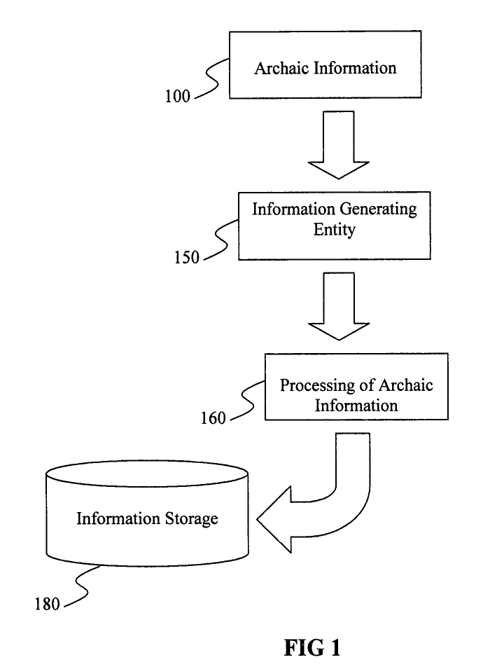

FIG. 1 shows an exemplary block diagram of the inventive method. The archaic information 100 (FIG. 1) such as the website's content or a book content, etc. is provided, sent or downloaded by the information generating entity 150 (FIG. 1) such as the webmaster, the website author, an author, and a third party for identifying at least one of a: proper or correct meaning and concept of a multi-conceptual word, proper or correct new meaning and new concept of a word, and proper or correct meaning of a new word. In the next step 160 (FIG. 1), the archaic information is at least one of a: analyzed, manipulated, reviewed, and approved, by the information generating entity for ultimately implementing at least one information for identifying at least one said identified meaning of a word. Finally the processed information from the previous step 160 (FIG. 1) optionally is stored in an information storage entity 180 (FIG. 1) for providing information to an information providing entity such as a search engine and a seeking information entity such as a search engine client.

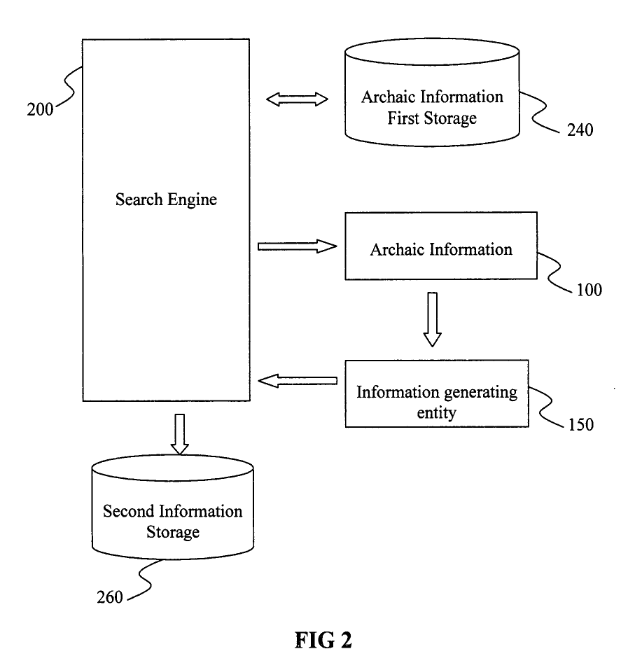

FIG. 2 illustrates a more detailing and limiting block diagram of another exemplary method of the disclosed inventive method. This time a search engine entity 200 (FIG. 2) accesses its first information storage means 240 (FIG. 2) for selecting and providing the archaic information 100 (FIG. 2) such as part of a website content, to an information generating entity 150 (FIG. 2) such as the website's administrator, for selecting or identifying the concept of a word that has several concepts present in said archaic information (website's content). Finally, the identified information (content) is send back to the search engine entity 200 (FIG. 2) which ultimately stores the reviewed information in a new information storage means 260 (FIG. 2). Please note that the archaic information storage means 240 (FIG. 2) could have also been used for storing the reviewed information.

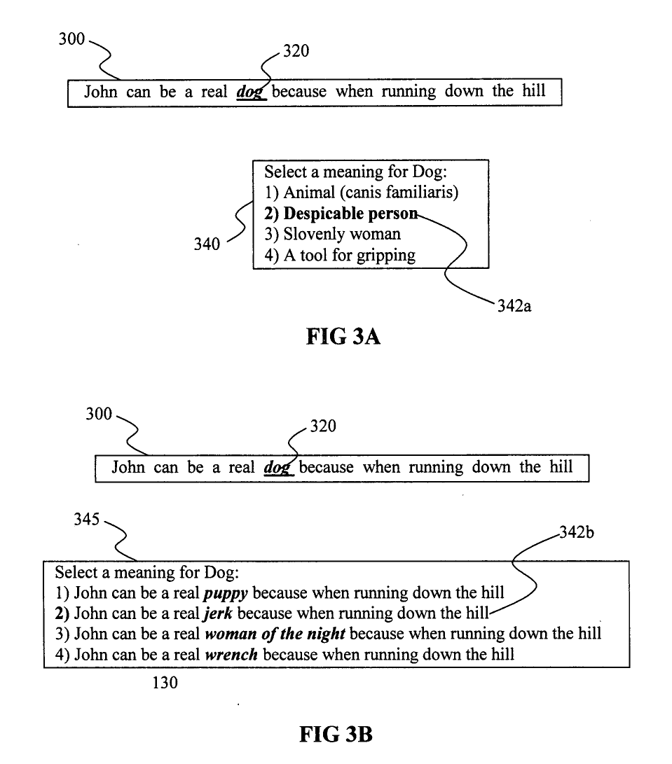

FIG. 3A and FIG. 3B illustrate non-limiting views of a program's interface for aiding a viewer to identify or select a meaning of a word that has multiple meanings or concepts in the archaic field of information. In FIG. 3A, the archaic corpus of information 300 (FIG. 3) comprises a text field or sentence wherein the text “dog” 320 (FIG. 3) is identified or highlighted from the remaining text of the sentence. In this example the viewer could right click (per se) the text “dog” 320 (FIG. 3A) for producing the menu 340 (FIG. 3) for selecting a meaning that the word “dog” has or assumes in the sentence (archaic field of information). In this particular example, the viewer selects the second option 342a (FIG. 3A); thus identifying the meaning of the word “dog” such as that for describing a despicable person. In FIG. 3B, the archaic information 300 (FIG. 3B) comprising the sentence containing the word in question or text “dog” 320 (FIG. 3B) is displayed with the menu 345 (FIG. 3B) providing a series of modified and/or alternative sentences sampling several meanings of the word “dog.” In this particular example, the viewer selects the second sampling sentence 342b (FIG. 3B), thus identifying the meaning or concept that the word “dog” implies in the particular sentence.

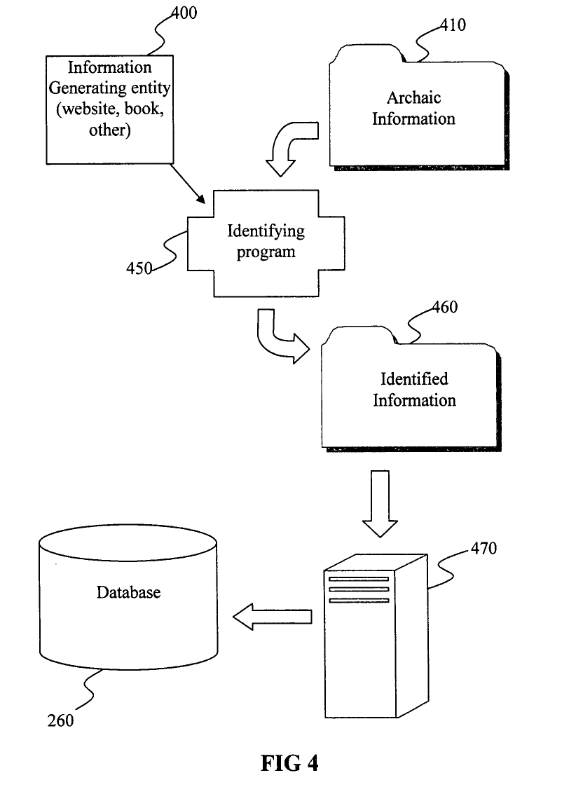

FIG. 4 illustrates the basic method of an information generating entity providing identified information such as a new meaning of a word to a search engine entity for searching. In this non-limiting example, the website's owner 400 (FIG. 4) interfaces an authoring or identifying program 450 (FIG. 4) for identifying a meaning or concept of a word or group of words present in the content of the website 410 (FIG. 4) or archaic information. After identifying the meaning(s) of a word(s) in the site content, the identified information 460 (FIG. 4) is received or accepted by the search engine entity 470 (FIG. 4) which performs a final accepting action including at least one of a: accepting, receiving, and storing the reviewed information of the site's content 460 (FIG. 4) that will be used for producing results when seeking information entities search for information in future instances. The illustration illustrates the additional step of the search engine entity 470 (FIG. 4) of storing the reviewed website information in a database 260 (FIG. 4).

FIG. 5 illustrates an information generating entity identifying a new meaning or unidentified meaning of a word present in the archaic content. The archaic information corpus 300 (FIG. 5) comprises four words. The first word 501 (FIG. 5) has no need for identification. The second word 502 (FIG. 5) also has no need for identification. The third word 503 (FIG. 5) has being identified comprising several meanings and is providing an optional menu for selecting a meaning of the word. However, the fourth word 504 (FIG. 5) having a new meaning or having several meanings is not being identified as a word with several meanings. As a result, the information generating entity then identifies the fourth word 504 (FIG. 5) such as highlighting it. In addition, FIG. 5 illustrates an optional entry field 560 (FIG. 5) for identifying said unidentified word or new meaning of the word 504 (FIG. 5), such as entering the word and its new or unidentified meaning. FIG. 5 also depicts a send function or button 580 (FIG. 5) for submitting the newly identified information.

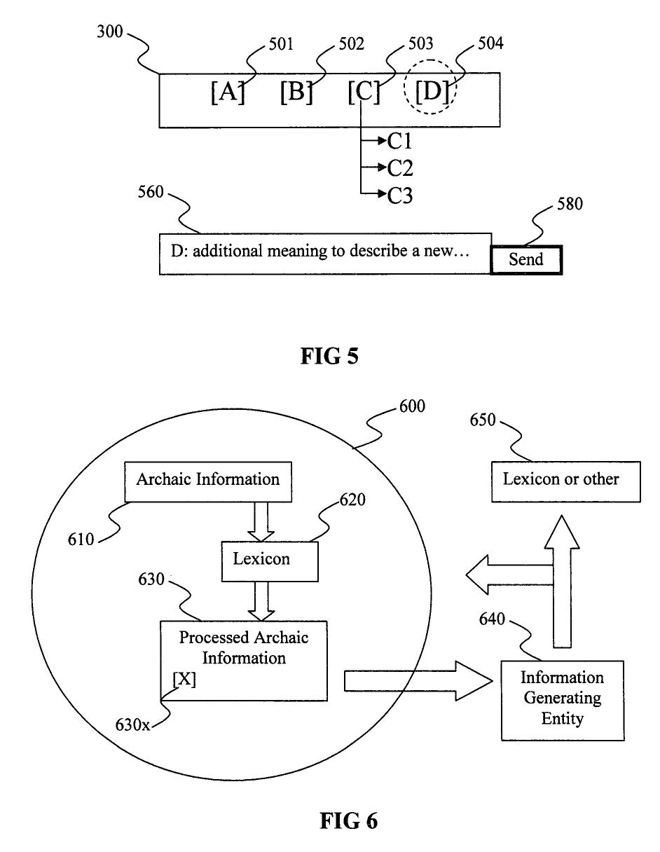

FIG. 6 illustrates an information searching entity identifying a new word and implementing the information generating entity for identifying a concept of said new word. The search engine entity 600 (FIG. 6) identifies an archaic information 610 (FIG. 6). The archaic information is interfaced with a lexicon 620 for identifying a word not present in the said lexicon 620 (FIG. 6). The processed archaic information 630 (FIG. 6) comprising a new discovered word 630x (FIG. 6) is then provided to the information generating entity 640 (FIG. 6) for identifying a concept or meaning for the new word 630x (FIG. 6), which after identifying, submits results back to the search engine entity 600 (FIG. 6) and/or any other entity 650 (FIG. 6) such as the lexicon producing entity.

Please note that in this disclosed inventive method the word “archaic” is implemented to describe any file or information produced either recently or old in nature, such as a recently entered word or a previously generated file from a database.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method of submitting and registering information for information searching can be appreciated. The described method overcomes the limitations and expenses encountered by information providers such as search engines, for identifying the proper concepts of current multi-conceptual words, new concepts for words and/or new words; therefore allowing such information providing entities to provide superior searching capabilities, standards and cognitive results, and permitting the quick and massive migration form a text standard to a superior identifier standard for information retrieval and storage.

1. A method for registering information for identifying a concept of a word, the method comprising the steps of:
a) Providing information to a selecting entity such as a client, a website provider, and a website information reviewer;
b) Said information comprising at least one of a: new word, new concept, and word capable of identifying several concepts
c) Said information selecting entity performing an identifying action including: identifying a new word, identifying a new concept of a word, and identifying a concept of a word capable of identifying several concepts,
d) Implementing said information from said information selecting entity for performing a registering action including at least one of a: storing said information, storing information identifying said information, searching for information, and retrieving of information.
